(19) United States
(12) Patent Application Publication
(10) Pub. No.: US 2026/0355944 A1
(43) Pub. Date: Nov. 12, 2026

(54) Dexterous Manipulation

(71) Applicant: Massachusetts Institute of Technology, Cambridge, MA (US)

(72) Inventors: Edward Adelson, Winchester, MA (US); Tao Chen, Cambridge, MA (US); Pulkit Agrawal, Cambridge, MA (US); Megha Tippur, Camridge, MA (US)

(21) Appl. No.: 19/487,193

(22) PCT Filed: May 21, 2024
(86) PCT No.: PCT/US2024/030329

§ 371 Date: Nov. 24, 2025

Related U.S. Application Data
(60) Provisional application No. 63/468,664, filed on May 24, 2023.
(60) Provisional application No. 63/601,581, filed on Nov. 21, 2023.

(51) Int. Cl. B25J 9/16; B25J 13/08; B25J 15/00; B25J 15/10

(52) U.S. Cl. CPC B25J 9/1612; B25J 9/161; B25J 9/163; B25J 9/1697; B25J 13/082; B25J 15/0004; B25J 15/103

(57) ABSTRACT

A robotic system has a hand with multiple finger whose state is controllable by a controller, an imaging device for providing depth images of the hand and objects held by the hand, and the controller. The controller implements a policy computation for processing data determined from depth images of an object held by the hand to provide commands for the hand to reorient the object held in the hand while maintaining support of the object during the reorientation. A training system determines values of configurable parameters of the policy computation module by processing data representing simulated manipulation of a plurality of shapes of objects by the hand, for example, using a reinforcement learning procedure.

### CROSS-REFERENCES TO RELATED APPLICATIONS

This application is a national stage application of International Application PCT/US2024/030329 filed May 21, 2024, which claims priority to U.S. Provisional Application No. 63/468,664 filed on May 24, 2023 and U.S. Provisional Application No. 63/601,581, filed on Nov. 21, 2023.

### STATEMENT AS TO FEDERALLY SPONSORED RESEARCH AND DEVELOPMENT

This invention was made with government support under FA8750-19-2-1000 awarded by the Air Force Office of Scientific Research and N66001-19-2-4034 awarded by the Naval Information Warfare Systems Command. The government has certain rights in the invention.

### BACKGROUND OF THE INVENTION

This invention relates to manipulation of objects in a robotic manipulator using vision feedback.

Control of manipulation of an object in a robotic manipulator, such as a robotic hand or other multiple grippers with multiple effectors, is a difficult problem, particularly based on visual feedback of the object in the manipulator, flexibility to manipulate objects of various and/or unknown shapes, avoidance of dropping the object during manipulation, and execution in a real-time control system.

### SUMMARY OF THE INVENTION

In the discussion below, reference is made to a robotic hand with fingers. However, it should be understood that “hand” can refer to a wide range of robotic effectors (including multi-element “limbs”) that are not necessarily in the form of a human hand, and “fingers” can refer to a wide range of forms of grippers or end effectors that are not necessarily in the form of human fingers. However, for the sake of illustration, a human hand-like effector is discussed below.

Aspects described herein relate to in-hand object reorientation using a robotic hand. In-hand object reorientation is a specific dexterous manipulation problem where the goal is to manipulate a hand-held object from an arbitrary initial orientation to an arbitrary target orientation. Object reorientation occupies a special place in manipulation because it is a precursor to flexible tool use. After picking a tool, the robot must orient the tool in an appropriate configuration to use it. For example, a screwdriver can only be used if it is oriented in a manner that aligns the head with the top of the screw. Object reorientation is, therefore, not only a litmus test for dexterity but also an enabler for many downstream manipulation tasks. In one aspect, in general, a robotic system is configured to reorient objects held in a hand of the robotic system, and in particular doing so without dropping (i.e., while maintaining support of) the object during the reorientation.

In another aspect, in general, a configuration procedure (also referred to as “training”) determines values of configurable parameters of the robotic system that enable the system to perform such reorientation.

In another aspect, in general, the robotic system is configured to update values of the configurable parameters as it gains real or simulated “experience” manipulating one or more objects, including using experience with one object to determine values of parameters used in manipulating other objects.

In another aspect, in general, a method of operating a robotic system performs the reorientation of an object and/or the updating of values of the configurable parameters.

In another aspect, in general, software stored on a non-transitory medium, when executed by a computer processor performs the steps of such a method. For example, the software may include controller instructions that are used by a processor integrated into the robotic system, and the software may include training instructions that are performed on a server computer (e.g., in the “cloud”). These instructions may include instructions for special-purpose processors, such as parallel graphics or tensor processing units (e.g., “GPUs”).

Aspects can include one or combinations of more than one of the following features.

The robotic system performs the reorientation independent of the shape of the object, for example, without having to determine the shape of the object before or even during manipulation.

During reorientation, the robotic system makes use visual feedback of the object held by the robotic hand. For instance, it makes use of at least one depth image of the object as it is being manipulated (e.g., acquired using a depth camera, such as an RBGD camera).

The depth image includes the hand and its fingers as well as the object, thereby encoding the state of the hand and the orientation of the object.

The robotic system further makes use of known (e.g., measured during operation or simulation) configuration of the hand (e.g., the joint angles of the fingers).

The known configuration of the hand and the depth image of the object are combined into a common data representation of the hand and object. For example, the common data representation is in a same data form for the hand and the image even if the hand and object parts are not integrated together.

The common representation comprises a three-dimensional point cloud (i.e., indicators at three-dimensional locations of surface points of the object), which may be real or synthetic. For example, the state of the hand and the known structure of the hand maps joint angles into the three-dimensional structure of the hand from which a point cloud of the hand is generated and combined with the point cloud derived from the depth image.

The data representation of the hand and object are input to a parameterized policy computation module, which outputs command data for changing the configuration of the hand.

The policy computation module further receives an input representing the desired change (e.g., incremental change, ultimate target, etc.) of orientation.

The robotic system operates in a control loop whereby it repeatedly receives input data (e.g., the point cloud data) and outputs command data for the hand. For example, the motion is dynamic (e.g., rather than quasi-static) accounting for dynamics (e.g., momentum, damping, etc.) of the hand.

The policy computation module comprises an artificial neural network.

The artificial neural network comprises a recurrent neural network or other neural network structure that maintains states between inputs.

The artificial neural network implements a sparse convolutional network. For example, the convolutional network operates on a voxel-based (e.g., surface points quantized to voxel coordinates) representation of the point cloud.

The sparse convolutional network may be particularly efficient in processing the relatively sparse data of a point cloud.

The configuration procedure (also referred to as “training”) and/or the updating of configuration values, makes use of a reinforcement learning (RL) approach.

The RL approach learns from simulated experience of the effect of hand commands on changes in orientation of the object.

The simulated experience is determined using a simulator of the mechanical behavior of the hand and object.

The mechanical behavior of the hand is based on a parameterized dynamical model of the hand.

The mechanical behavior of the hand is learned (i.e., values of the parameters of the dynamical model are determined) prior to the reinforcement learning, including by performing a system identification procedure.

The robotic fingers have rigid skeletons covered in a soft gel elastomer, which provides compliance in the fingertips while the endoskeleton helps to maintain the integrity of the finger shape while manipulating objects. The system may use characteristics of the of the compliant portions in predicting the three-dimensional structure (e.g., point cloud) of the hand.

The system identification procedure includes a parallel search for mechanical system parameter values, for instance, evaluating many different sets of system parameters in parallel to identify parameters that best match recordings of true physical behavior of the hand.

The reinforcement learning procedure makes use of simulated “experience” data.

The simulated data includes simulated point clouds determined from simulated positions and orientations of the hand and object being manipulated without necessarily simulating the image acquisition procedure.

The reinforcement learning procedure rewards motion toward the goal orientation.

The reinforcement learning procedure penalizes motion associated with possible dropping of an object being manipulated.

During training with simulated data, a simulated surface is disposed below the object being manipulated. The reinforcement learning procedure penalizes (i.e., provides a lesser reward) when the object contacts (e.g., receives at least some support from) the surface, thereby rewarding manipulation (reorientation) that is performed entirely above the surface (i.e., “in the air” without dropping the object).

During training, the simulated surface is removed from (or otherwise modified, for example, moved further away) the simulation once a certain level of manipulation performance is achieved through the training.

In some examples, the reinforcement learning procedure is performed during actual (i.e., non-simulated) manipulation of objects.

In some examples, the simulator of the mechanical behavior of the hand is updated during actual manipulation of an object (i.e., under control of a reorientation policy), and further simulated behavior is generated and used by a reinforcement learning procedure to further update configuration values.

Other imaging modalities may be used, include laser scanning (e.g., 3D profilometry, LIDAR), stereo vision cameras, or ultrasound or radio frequency imaging modalities.

In addition to imaging modalities, other manipulator data such as contact forces (e.g., pressure, sheer) on the fingers may be combined with the point clouds.

Among other advantages, the robotic system may satisfy multiple criteria in that it can reorient objects into substantially any orientation, generalize to new object shapes and properties, and operate in real-time using data from off the shelf sensors.

Other features and advantages of the invention are apparent from the following description, and from the claims.

### BRIEF DESCRIPTION OF THE DRAWINGS

FIG. 1 is a schematic diagram of a robotic system orienting an object.

FIG. 2 shows the runtime working mechanism of a robotic system orienting an object.

FIG. 3 shows sequences of object manipulation by the robotic system shown in FIG. 1.

FIGS. 4A and 4B show an exemplary runtime processing of the point cloud conversion block in FIG. 2.

FIGS. 5A and 5B show detailed deep learning architecture of the policy computation module in FIG. 2.

FIG. 6 shows a teacher-student framework for training the policy computation module in FIG. 2.

### DETAILED DESCRIPTION

### 1 Overview

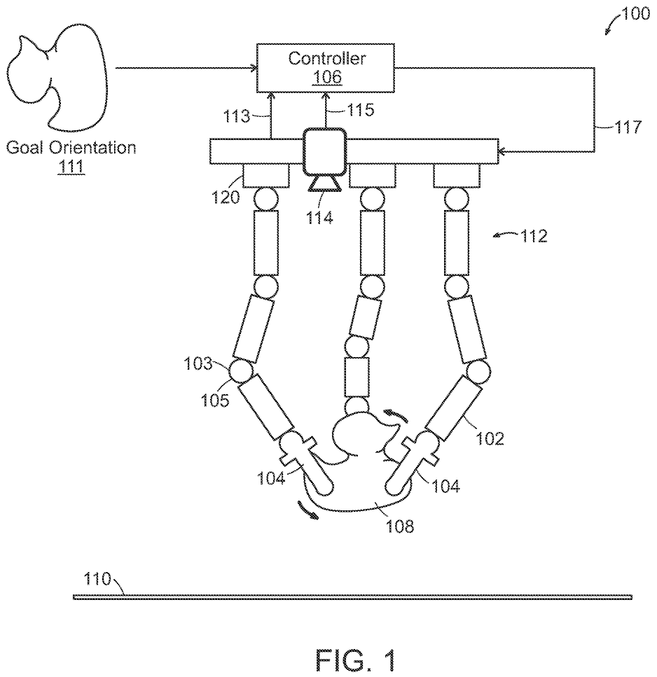

Referring to FIG. 1, a robotic system 100 for dexterous manipulation control a robotic hand 112 performs dexterous manipulation tasks such as re-arranging objects, loading dishes in a dishwasher, fastening bolts, cutting vegetables, and other forms of tool use. Aspects described below are related to the specific task of in-hand object reorientation, but it should be understood that the system is not limited to in-hand object reorientation tasks and can perform a wide variety of dexterous manipulation tasks.

The system 100 includes the robotic hand 112, a camera 114 (e.g., a depth camera, i.e., an imaging device), and a controller 106. The robotic hand 112 includes joint encoders 120, fingers 102 with fingertips 104, and motors or other actuators 103 at its joints 105. The controller 106 receives a goal orientation 111 of an object 108, an image of the object 108 captured by the camera 114 (i.e., image data 115), and joint position data 113 for the robotic hand as input and generates commands 117 (e.g., actuator commands) to cause the fingers 102 of the robotic hand 112 to move and manipulate the object 108 in a manner analogous to the way a human hand would manipulate the object. In some examples, the controller 106 generates the commands 117 according to a parameterized policy computation module, described in greater detail below.

For an in-hand object orientation task, the commands 117 cause the robotic hand 112 to move through a series of steps that cause the object 108 to rotate from a current orientation (as captured by the camera 114) to the goal orientation 111 without dropping the object 108.

In general, the object 108 can have any shape and may sometimes be partially supported by a surface 110 or at other times only supported by the fingers 102 without falling off (i.e., through the air) throughout the reorientation. In some examples, multiple cameras are placed around the robotic system's workspace to reduce occlusion in viewing the object being manipulated. The camera and the robotic hand may both be located below the object (i.e., an upwards facing hand configuration) or the camera and the robotic had may be located above the object (i.e., a downwards facing hand configuration, shown in FIG. 1).

### 2 Runtime Operation

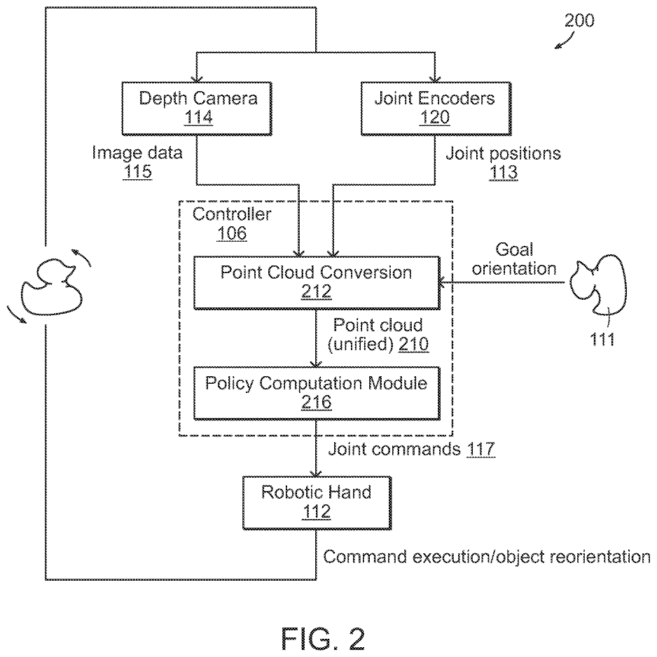

Referring to FIG. 2, a schematic diagram 200 for the robotic system 100 illustrates one example of a runtime operation of the robotic system 100. In general, the system operates in a loop, where the controller 106 first receives image data 115 from the camera 114 (e.g., a depth image of the robotic hand 112 and the object 108), position data 113 from the robotic hand (e.g., data from joint encoders 120 of the robotic hand 112), and the goal orientation 111 as inputs. In some examples, the goal orientation 111 of the object is provided as a scanned image from a 3D scanner before it is converted into a point cloud.

The controller 106 includes a point cloud conversion module 212 and a policy computation module 216. The current image data 115, the joint position data 113, and the goal orientation 111 are provided to the point cloud conversion module 212 as inputs. The point cloud conversion module 212 processes the inputs to generate point cloud data 210 to represent orientatins of the object 108 and the joint positions 113 of the fingers 102 (as described in more detail below). In some examples, point cloud data refers to a set of data points in a 3D coordinate system generated by sampling discrete points on the meshes of an object's surface in a 3D image.

The point cloud data 210 is provided to the policy computation module 216, which processes the point cloud data 210 to generate the joint commands 117. As is described in greater detail below, in some examples, the policy computation module 216 includes a model that is pre-trained by deep reinforcement learning (RL). The robotic hand 112 then executes the commands 117 to cause the robotic hand 112 to move to a new configuration, which reorients the object 108. This process repeats, incrementally reorienting the object 108 until it is in the goal orientation 111.

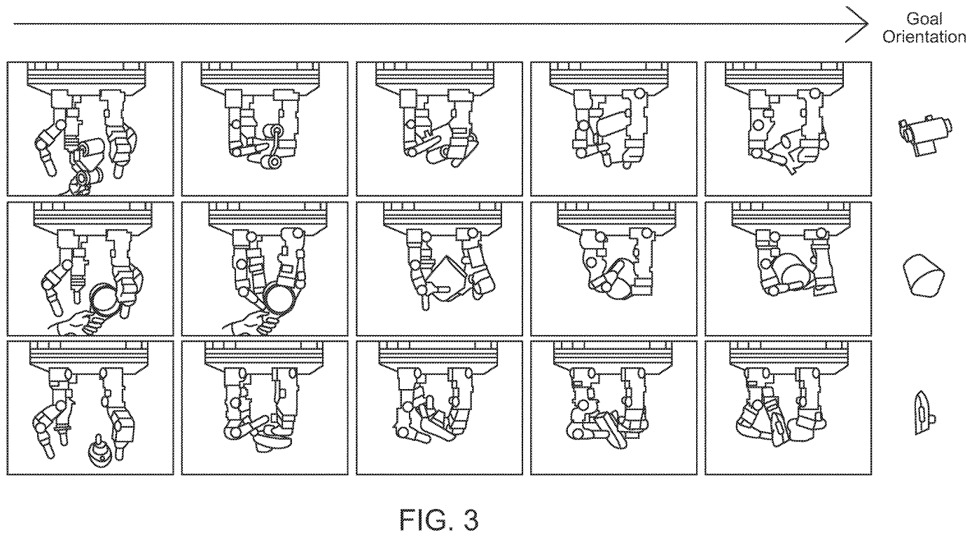

Referring to FIG. 3, examples of sequences of steps taken by the robotic hand 112 to reorient an object from an initial orientation to a goal orientation are shown (proceeding from the left side of the page to the right side of the page).

### 2.1 Point Cloud Conversion Module

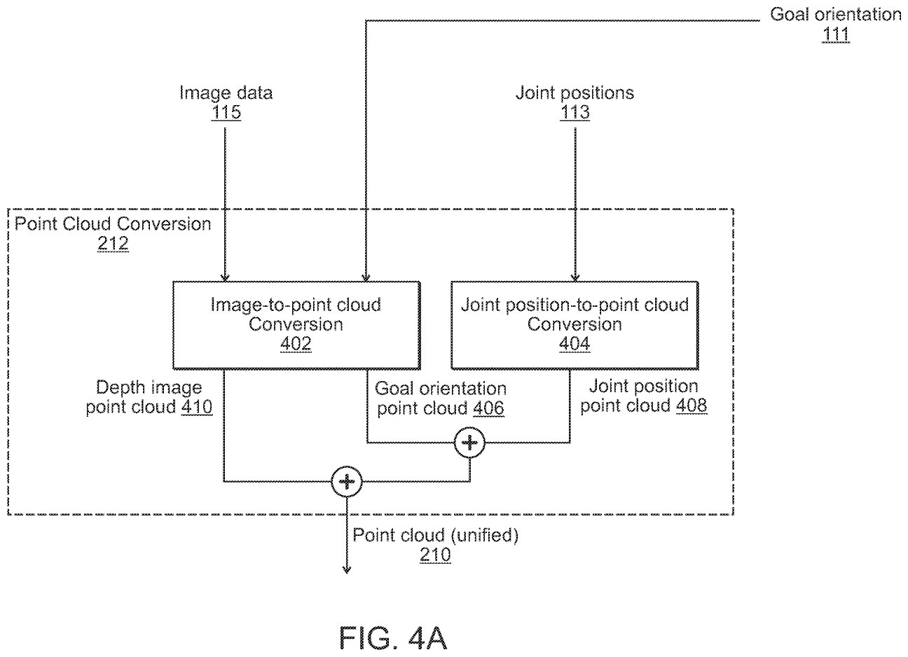

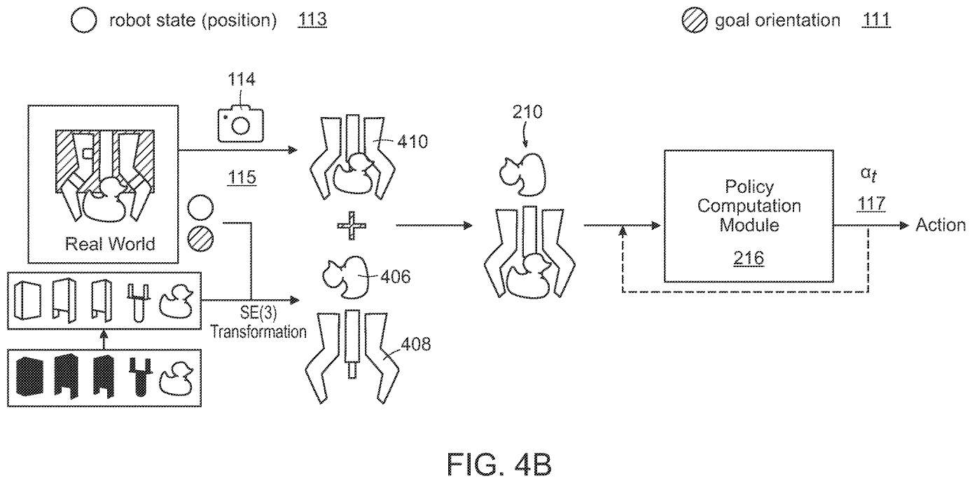

Referring to FIGS. 4A and 4B, as is noted above, point cloud conversion module 212 receives image data 115 from the camera 114, the goal orientation 111, and joint positions 113 as inputs and processes the inputs to generate a unified point cloud 210. In some examples, point cloud conversion 212 includes channels such as an image-to-point cloud conversion module 402, and a joint position-to-point cloud conversion module 404.

The image-to-point cloud conversion module 402 receives the image data 115 and the goal orientation 111 and processes the inputs to generate a depth image/current state point cloud 410 and a goal orientation point cloud 406. To generate the current state point cloud 410, the image-to-point cloud conversion 402 converts image data to a point cloud using the camera's data transformation matrices. The depth image point cloud 410 is also called the exteroceptive point cloud.

To generate the goal orientation point cloud 406, the image to point cloud conversion module 402 receives the goal orientation image data 111 as input and processes the input in a similar way as processing the current state point cloud 410 as described above. In some examples, the goal orientation image is a scanned 3D image taken by, for example, an iPad App.

The joint-position-to-point cloud conversion module 404 receives the joint positions 113 as input and processes the joint positions to generate a joint position point cloud 408 representing points sampled on the surface of the fingers 102. To generate the joint position point cloud 408, the joint-position-to-point cloud conversion module 404 converts the joint angle information into link poses via forward kinematics.

In some examples, the joint angles are converted into a point cloud as follows: Using the robot's CAD model, points are uniformly sampled on each link and the samples are cached. Given a sequence of joint positions, forward kinematics is used to compute the pose of each link and accordingly transform each of the associated pre-cached point clouds. The concatenated point cloud of all links is called a proprioceptive point cloud.

Finally, the unified point cloud 210 representing the entire scene is formed by combining the current state point cloud 410, the goal orientation point cloud 406, and the joint position point cloud 408. For example, the synthetic/unified point cloud is the union of point clouds of all the links, the object being manipulated/reorientated, and the object in the goal orientation as:

$${P}_{t}^{s} = {⋃}_{j = 1}^{j = M} {P}_{t}^{{I}_{j}}$$

where M is the total number of links (bodies) in the environment. The point cloud

$${P}_{t}^{s}$$

can be efficiently generated using matrix multiplication.

### 2.2 Policy Computation Module

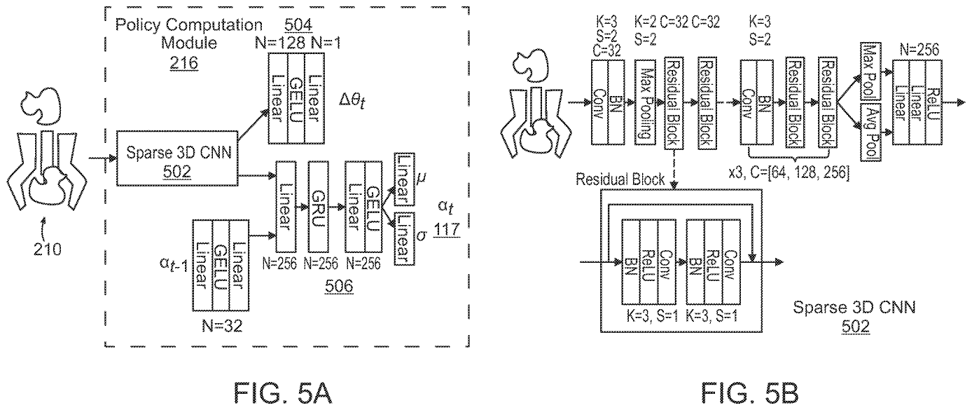

As mentioned above, the unified point cloud 210 is provided to the policy computation module 216, which processes the unified point cloud 210 to generate joint commands 117. Referring to FIG. 5A, in one embodiment for fast computation, the policy computation module 216 includes a sparse convolutional neural network (CNN) 502, a reward deep neural network 504, and a command deep neural network 506. The sparse CNN 502 is designed for training the student policy to process point cloud (Pt) using the Minkowski Engine, which supports various functions that can be built on a sparse tensor network. This convolutional network has a high capacity to make it possible to learn the reorientation of multiple objects.

The sparse 3D CNN 502 receives the unified point cloud 210 and processes it to generate convolution results in terms of position, speed, and acceleration. Referring to FIG. 5B, in some examples, the sparse 3D CNN 502 has a multi-level architecture including components such as residual blocks.

Referring again to FIG. 5A, the convolution results are provided by the sparse 3D CNN 502 to both the reward deep neural network 504 and the command deep neural network 506. The reward deep neural network 504 processes the convolution results to generate a reward signal. In embodiments where the policy computation module 216 is continuously trained in a reinforcement learning mode or during a training phase use of the policy computation module 216, the reward signal Δθₜ as the distance to target orientation is used to update the parameters of the policy computation module 216 for future tasks. In other embodiments, where the parameters of the policy computation module 216 are fixed during runtime, the reward signal Δθₜ is not used during runtime.

The command deep neural network 506 processes the convolution results to generate the joint commands 117. In some examples, the sparse convolution neural network 502 and the command deep neural network 506 allow real-time control of the robotic hand 112 by speeding up the output of joint commands 117 (i.e., aₜ) while monitoring as the reward signal, Δθₜ.

### 3 Policy Training

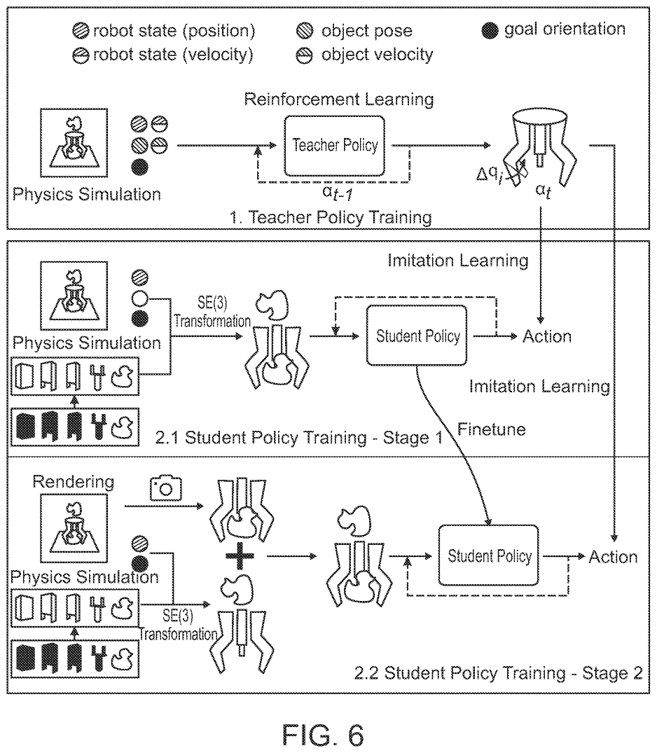

Referring to FIG. 6, steps for training the machine learning policy are shown. In particular, given a random object in a random initial pose, the robot is tasked to reorient the object to a user-provided target orientation in SO(3) space. A single vision-based object reorientation controller/policy is trained in simulation to reorient hundreds of objects. The controller trained in simulation is directly deployed in the real world (i.e., zero-shot transfer). The choices in the experimental setup have been made to support future deployment of reorientation in service of tool use and on a mobile manipulator.

In some examples, the vision policy of policy computation module 216 runs at a high enough frequency to enable real-time control. A two-stage student policy approach is devised for training the vision policy that first uses a synthetic point cloud without the need for rendering and is then finetuned with rendered point cloud to minimize the sim-to-real gap.

The teacher policy is an MLP network consisting of three hidden layers (512, 256, 256 neurons) and ELU activation functions.

The success criterion for the training process defines when the agent has accurately reoriented the object in the target configuration. Its purpose is two-fold: a reward signal during training and a criterion that signals success to stop the reorientation policy and thereby end the episode during training. A straightforward success criterion is judging whether an object's orientation is close to the target orientation (orientation criterion). The controller learned using the criterion when evaluated in simulation results in a behavior wherein the robotic fingers stabilize the object when its orientation is close to the target. However, the same controller, when evaluated in the real world, often does not result in fingers stopping when the object orientation is close to the target leading to overshooting. Consequently, instead of stopping, the object oscillates around the target orientation. This is believed to be a result of sim-to-real gaps, including the control latency, observation noise, and the difference in dynamics, etc. This issue is ameliorated by expanding the definition of success criterion to penalize finger and object motions explicitly. The task is considered completed successfully in the simulation if all the following three criteria are satisfied:
Orientation Criterion is satisfied when |Δθₜ|<\dot{θ} where Δθₜ is the distance between the object's current and target orientation.
Finger motion criterion requires the joint motion of the robot to be small and is satisfied when ∥\dot{q}ₜ∥<\dot{q̅} and ∥aₜ∥<ā where \dot{q}ₜ is the joint velocities at time step t, aₜ is the policy output.
Object motion criterion requires the object's velocity to be small. It is satisfied when

$$‖ {v}_{t}^{o} ‖ < \overline{v} and ‖ {w}_{t}^{o} ‖ < \overline{w}$$

where

$${v}_{t}^{o} , {w}_{t}^{o}$$

denote object's linear and angular velocities respectively.

θ̅, \dot{q̅}, ā, v̅, w̅ are manually defined thresholds. The finger and object motion criteria act as regularizers to explicitly encourage the policies to slow down the motion near the end.

The problem of learning the controller, π, is modeled as a finite-horizon discrete-time decision process with horizon length T. The policy π takes as input sensory observations (oₜ) and outputs action commands (aₜ) at every time step t. Learning π using RL is data inefficient when the observation (oₜ) is high-dimensional (e.g., point clouds). The reason is that the policy needs to simultaneously learn which features to extract from visual observations and what are the high-rewarding actions. The problem would be simplified if one of these factors were known: learning a policy via RL from sufficient state information would be much easier than direct learning from sensory observations. Similarly, a priori knowledge of high-rewarding actions would reduce the data requirements of learning from visual observations.

In the first step, a teacher policy is trained in simulation with RL using low-dimensional state space that includes privileged information. In the case of in-hand object reorientation, privileged information includes quantities such as fingertip velocity, object pose, and object velocity that can be directly accessed from the simulator but can be challenging to measure in the real world. Because the teacher policy operates from a low-dimensional state space, it can be more efficiently trained using RL. Next, to enable operation in the real world, one can either train a perception system to predict the privileged information or train a second student policy to predict high-rewarding teacher actions from raw sensory observations via supervised learning.

An underlying assumption of the two-stage student policy training paradigm is that a low-dimensional state for learning a teacher policy can be identified. Because there are no tools available to theoretically analyze if a particular choice of state space is sufficient for policy learning, selecting the state inputs for the teacher policy is a manual process based on human intuition. At first, object reorientation might seem to require knowledge of object shape since the controller must reason about where to make contact. If object shape is necessary, then it will not be possible to reduce depth observations into a low-dimensional state. However, past work found that even without any shape information, it is possible to train RL policies to achieve good reorientation performance on a diverse set of objects in simulation. Therefore, teacher-student training can be leveraged to simplify the learning of object reorientation.

To deploy the policy in the real world, an end-to-end student policy is chosen that takes as input the raw sensory observations and is optimized to match the actions predicted by the teacher policy via supervised learning. Because supervised learning is considerably more data efficient than RL, such an approach solves the hard problem of learning a policy from raw sensory observations. A novel two-stage student training (Teacher-student²) framework (see FIG. 6, described in detail below) is developed that substantially speeds up the vision student policy learning. Using this framework, one is able to learn a vision policy that operates across a diverse set of objects and generalizes to objects with novel shapes and physical parameters.

3.1 Teacher Policy: Reinforcement Learning with Privileged Information

The learning of teacher policy (π^{ε}) is formulated as a reinforcement learning problem where the robot observes the current observation

$$( {o}_{t}^{ε} ) ,$$

takes an action (aₜ), and receives a reward (rₜ) afterward. A single policy (π^{ε}) is trained across multiple objects to maximize the expected discounted episodic return:

$${π}^{ε *} = arg {max}_{{π}^{ε}} 𝔼 [ {\sum }_{t = 0}^{T - 1} {γ}^{t} {r}_{t} ] .$$

Since the observation oₜ at a single time step t does not convey the full state information such as the geometric shape of an object, the setup is an instance of Partially Observable Markov Decision Process (POMDP). However, for the sake of simplicity and based on the finding that knowledge of object shape may not be critical as discussed above, the policy is modeled as a Markov Decision Process (MDP): aₜ=π^{ε*}(oₜ; aₜ₋₁). The policy also takes as input the previous action (aₜ₋₁) to encourage smooth control.

The inputs to the teacher policy, oₜ, include proprioceptive state information, object state, and target orientation. Position controllers are used to actuate the robot joints at a frequency of 12 Hz. The policy outputs the relative joint position changes aₜ∈ [symbol] ^{3G}. Instead of directly using aₜ, the exponential moving average of actions a̅ₜ̅=αaₜ+(1−α)a̅ₜ̅₋̅₁̅ is used for smooth control, where α∈[0, 1] is a smoothing coefficient. In the experiments, it is set that α=0.8. Given the smoothed action a̅ₜ̅, the target joint position at the next time step is:

$${q}_{t + 1}^{t g t} = {q}_{t} + \overline{{a}_{t}} .$$

The reward function for the hand to reorient objects on a table is first described below. The first term in the reward function (Equation 1) is the success criteria for the task. However, since this only provides sparse reward supervision, the criterion by itself is insufficient for successful learning. Therefore, additional reward shaping terms are added to encourage reorientation. A dense reward term is used that encourages minimization of the distance (Δθₜ) between the agent's current and target orientation (Equation 2). The agent is penalized for moving fingertips far away from the object (Equation 3). Without this term, fingers barely made any contact with the object during training. The agent is also penalized for expending energy (Equation 4) and for pushing the object too far from the robot's hand (Equation 5) in which case the episode is also terminated. The reward terms are mathematically expressed as:

$$\begin{matrix}{r}_{1 t} = {c}_{1} \text{?} ( Task successful ) & sparse task reward & ( 1 ) \\ + {c}_{2} \frac{1}{\vert {Δθ}_{t} \vert + {ϵ}_{θ}} & dense task reward & ( 2 ) \\ + {c}_{3} {\sum }_{i = 1}^{G} {‖ {p}_{t}^{{f}_{i}} - {p}_{t}^{o} ‖}_{2}^{2} & keep fingertip close to the object & ( 3 ) \\ + {c}_{4} {\vert {\dot{q}}_{t} \vert}^{T} \vert {τ}_{t} \vert & energy reward & ( 4 ) \\ + {c}_{5} \text{?} ( {‖ {p}_{t}^{o} ‖}_{2}^{2} > \overline{p} ) & penalty for pushing the object away & ( 5 )\end{matrix}$$

Where c₁, c₂>0 and c₃, c₄, c₅<0 are coefficients, [symbol] is an indicator function, ϵ_{θ} and p̅ are constants,

$${p}_{t}^{{f}_{i}}$$

is the fingertip positon of i^{th} finger,

$${p}_{t}^{o}$$

is the object center position, τₜ is the vector of the joint torques.

Using the aforementioned reward function, reorientation policies that used the support of a surface/table can be successfully trained. Next, to enable the more challenging behavior of reorienting objects in the air, the following are added: (1) penalty for the contact between the object and table (Equation 7) and (2) penalty for using the penultimate joint instead of the fingertip for reorientation (Equation 8). While the term in Equation 8 is not critical, it results in more natural looking behaviors. The overall reward function is:

$$\begin{matrix}{r}_{2 t} = {r}_{1 t} & ( 6 ) \\ + {c}_{6} \text{?} ( object contacts with the table ) & ( 7 ) \\ + {c}_{7} {\sum }_{i = 1}^{N} \text{?} ( {p}_{t , z}^{{f}_{i}} > \overline{{p}_{z}} ) & ( 8 )\end{matrix}$$

where c₆, c₇<0 are coefficients.
3.2 Student Policy-Imitation Learning from Depth Observations

Referring to FIG. 6, the student policy (π^{S}) is trained in simulation with the purpose of being deployed in the real world. Since the sim-to-real gap for depth data is less pronounced than RGB data, only the depth images provided by the camera along with readings from joint encoders are used. The depth data are represented as a point cloud in the robot's base link frame. To enable the neural network representing π^{S} to model the spatial relationship between the fingers and the object, the robot's current configuration is expressed by showing the policy a point cloud representing points sampled on the surface of the fingers. The point cloud obtained from the camera 114 is concatenated along with the generated point cloud of the robotic hand 112. This scene point cloud is denoted as

$${P}_{t}^{s} .$$

Instead of providing the goal orientation as a pose which has generalization issues discussed above, the goal is represented as the object's point cloud in the target orientation p^{g}. In other words, the policy sees how the object should look in the end (see the top left of FIG. 5A).

The input to π^{S} is the point cloud

$${P}_{t} = {P}_{t}^{s} ⋃ {P}^{g}$$

(see FIG. 5A). The results show that merging

$${P}_{t}^{s}$$

and p^{g} before they are input to the network leads to faster learning. Without direct access to object velocity, it is necessary to integrate temporal information in TS, for which we use the gated recurrent unit in the network. The student policy TS is trained to imitate the teacher policy π^{ε}.

### 3.2.1 Stage 1: Details of Synthetic Point Cloud

In stage 1, the simulation is not used for rendering but only for physics simulation. The point cloud used in the simulation is generated from the simulated depth images including uniformly sampled points on the object 108 and finger 102 meshes by the image-to-point cloud conversion 402 in the same way as described above in Section 2. The synthetic point cloud is also complete (i.e., no occlusions), which makes training easier.

### 3.2.2 Stage 2: Details of Rendered Point Cloud

In stage 2, depth images from the simulator at each time step are acquired and converted to point clouds (exteroceptive point cloud). Note that such a point cloud is not complete due to occlusions from a single camera. The joint angle information into link poses via forward kinematics is also converted and then the complete point cloud of the robot (proprioceptive point cloud) is generated. Note that such a proprioceptive point cloud of a robot can be easily obtained in the real world in real-time as well since the joint positions on the real robot can be obtained. The policy input consists of the union of the exteroceptive point cloud and the proprioceptive point cloud.

### 3.2.3 Overcoming the Simulation to Reality Gap

There are two main sources of gap between simulation and reality. The first one is dynamics gap that arises from differences in robot dynamics, the approximation in the simulator's contact model, and differences in object dynamics that depend on material properties such as friction, etc. The other source is perception gap caused by differences in statistics of sensor readings and/or noise. One way to overcome these gaps is to train a single policy across many different settings of the simulation parameters (i.e., domain randomization). The success of domain randomization hinges on the hope that the real world can be well approximated by one of the many simulation parameter settings used during training. The chances that one of the parameter settings being used in simulation being close to the real world increases by randomizing parameters over a larger range. However, excessive randomization may result in an overly conservative policy with low performance. Therefore, design choices are made that reduce the need for domain randomization, which is used only when needed.

The perception gap is reduced by using only depth readings from the camera which is represented as a point cloud and is sufficient for reorienting objects with different shapes. To account for noise in depth readings, noise is added to the simulated point cloud. The dynamics gap can be reduced by identifying simulation parameters that are closest to the real world. While such identification is possible for the robotic manipulator, it is infeasible to do so for object dynamics that vary in material, mass distribution, etc. Therefore, system identification on the robot dynamics is performed and only small randomization is used to account for unmodeled errors. Larger range of domain randomization is used on the object and environment dynamics. To make the policy more robust to unmodeled real-world physics, random forces are applied on the object during training which pressures the policy to reorient objects while being robust to external disturbance. Lastly, to increase compliance and friction between the object and the manipulator, soft fingertips are used. Such a choice makes the system more tolerant of errors in control commands. Empirically, it is noticed that soft fingertips make the robot less aggressive and result in fewer overshoots.

### 3.3 System Identification of Robot Dynamics

The Unified Robot Description Format (URDF) models are built for robotic hands using their CAD models. While accurate kinematics parameters can be obtained from the CAD model, the dynamics parameters, such as joint damping and stiffness, must be estimated. One way of identifying dynamics parameters is to write down the equations of motion (or the dynamics model) and solve for the unknown variables using the collected robot's motion trajectories. The Isaac Gym simulator being used already has a built-in dynamics model. But because the simulator's code is not open source, there is no access to the precise dynamics model nor any access to gradients of dynamics parameters. Therefore, a black-box approach is used that leverages the ability of Isaac Gym to perform massively parallel simulations. A large number of simulations are spawned with different dynamics parameters and the one that has the closest match to the real robot's motion is used.

Let λᵢ∈Λ denote the dynamics parameter of the i^{th} simulated robot (C^{λ}^{ᵢ}), where Λ denotes the entire set of dynamics parameter values over which search is performed. To evaluate similarity between the motion of C^{λ}^{ᵢ} and the real robot (C^{real}), the following score is computed:

$$h ( {q}_{A}^{{C}^{real}} ( \cdot ) , {q}_{A}^{{C}^{{λ}_{i}}} ( \cdot ) ) = - {‖ {q}_{A}^{{C}^{real}} ( \cdot ) - {q}_{A}^{{C}^{{λ}_{i}}} ( \cdot ) ‖}_{2}^{2} ,$$

where

$${q}_{A}^{C} ( \cdot )$$

represents the joint position trajectories of a robot C given action commands A(·). The closer the motion of the simulated robot to the real-world, the higher the score. The black-box optimization method is used, which is an instance of evolutionary search algorithm, to determine the optimal dynamics parameter:

$${λ}^{*} = arg {max}_{λ ∈ Λ} h ( {\dot{q}}_{A}^{{C}^{real}} ( \cdot ) , {q}_{A}^{{C}^{λ}} ( \cdot ) ) .$$

Note that it might be impossible to find a simulated robot that exactly matches the real robot due to approximate parameterization of real-world dynamics in simulation and the stochasticity in the real-world resulting from actuation/sensing noise.

### 3.4 Real-World Observation

The observation consists of the joint positions of each motor in the robotic hand 112 and the depth image from the depth camera 114. To automatically stop the robot, a predictor is trained that re-uses features from the policy computation module 216 to predict |Δθₜ| (see FIG. 5A). The robot is stopped when

$${Δθ}_{t}^{pred} < \overline{θ}$$

and ∥aₜ∥<ā.

### 4 Inventive Aspects

Inventive aspects described above include a method of operating a robotic system that performs the reorientation of an object and/or the updating of values of the configurable parameters. In another aspect, a non-transitory machine-readable medium has instructions stored thereon, which when executed by a computer processor cause the processor to perform the steps of such a method. For example, the software may include controller instructions that are used by a processor integrated into the robotic system, and the software may include training instructions that are performed on a server computer (e.g., in the “cloud”). These instructions may include instructions for special-purpose processors, such as parallel graphics or tensor processing units (e.g., “GPUs”).

Inventive aspects can include one or combinations of more than one of the following features.

The robotic system performs the reorientation independent of the shape of the object, for example, without having to determine the shape of the object before or even during manipulation.

During reorientation, the robotic system makes use visual feedback of the object held by the robotic hand. For instance, it makes use of at least one depth image of the object as it is being manipulated (e.g., acquired using a depth camera, such as an RBGD camera).

The depth image includes the hand and its fingers as well as the object, thereby encoding the state of the hand and the orientation of the object.

The robotic system further makes use of known (e.g., measured during operation or simulation) configuration of the hand (e.g., the joint angles of the fingers).

The known configuration of the hand and the depth image of the object are combined into a common data representation of the hand and object. For example, the common data representation is in a same data form for the hand and the image even if the hand and object parts are not integrated together.

The common representation comprises a three-dimensional point cloud (i.e., indicators at three-dimensional locations of surface points of the object), which may be real or synthetic. For example, the state of the hand and the known structure of the hand maps joint angles into the three-dimensional structure of the hand from which a point cloud of the hand is generated and combined with the point cloud derived from the depth image.

The data representation of the hand and object are input to a parameterized policy computation module, which outputs command data for changing the configuration of the hand.

The policy computation module further receives an input representing the desired change (e.g., incremental change, ultimate target, etc.) of orientation.

The robotic system operates in a control loop whereby it repeatedly receives input data (e.g., the point cloud data) and outputs command data for the hand. For example, the motion is dynamic (e.g., rather than quasi-static) accounting for dynamics (e.g., momentum, damping, etc.) of the hand.

The policy computation module comprises an artificial neural network.

The artificial neural network comprises a recurrent neural network or other neural network structure that maintains states between inputs.

The artificial neural network implements a sparse convolutional network. For example, the convolutional network operates on a voxel-based (e.g., surface points quantized to voxel coordinates) representation of the point cloud.

The sparse convolutional network may be particularly efficient in processing the relatively sparse data of a point cloud.

The configuration procedure (also referred to as “training”) and/or the updating of configuration values, makes use of a reinforcement learning (RL) approach.

The RL approach learns from simulated experience of the effect of hand commands on changes in orientation of the object.

The simulated experience is determined using a simulator of the mechanical behavior of the hand and object.

The mechanical behavior of the hand is based on a parameterized dynamical model of the hand.

The mechanical behavior of the hand is learned (i.e., values of the parameters of the dynamical model are determined) prior to the reinforcement learning, including by performing a system identification procedure.

The robotic fingers have rigid skeletons covered in a soft gel elastomer, which provides compliance in the fingertips while the endoskeleton helps to maintain the integrity of the finger shape while manipulating objects. The system may use characteristics of the of the compliant portions in predicting the three-dimensional structure (e.g., point cloud) of the hand.

The system identification procedure includes a parallel search for mechanical system parameter values, for instance, evaluating many different sets of system parameters in parallel to identify parameters that best match recordings of true physical behavior of the hand.

The reinforcement learning procedure makes use of simulated “experience” data.

The simulated data includes simulated point clouds determined from simulated positions and orientations of the hand and object being manipulated without necessarily simulating the image acquisition procedure.

The reinforcement learning procedure rewards motion toward the goal orientation.

The reinforcement learning procedure penalizes motion associated with possible dropping of an object being manipulated.

During training with simulated data, a simulated surface is disposed below the object being manipulated. The reinforcement learning procedure penalizes (i.e., provides a lesser reward) when the object contacts (e.g., receives at least some support from) the surface, thereby rewarding manipulation (reorientation) that is performed entirely above the surface (i.e., “in the air” without dropping the object).

During training, the simulated surface is removed from (or otherwise modified, for example, moved further away) the simulation once a certain level of manipulation performance is achieved through the training.

In some examples, the reinforcement learning procedure is performed during actual (i.e., non-simulated) manipulation of objects.

In some examples, the simulator of the mechanical behavior of the hand is updated during actual manipulation of an object (i.e., under control of a reorientation policy), and further simulated behavior is generated and used by a reinforcement learning procedure to further update configuration values.

Other imaging modalities may be used, include laser scanning (e.g., 3D profilometry, LIDAR), stereo vision cameras, or ultrasound or radio frequency imaging modalities.

In addition to imaging modalities, other manipulator data such as contact forces (e.g., pressure, sheer) on the fingers may be combined with the point clouds.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

1. A robotic system comprising:
a hand comprising a plurality of fingers whose state is controllable by a controller;
an imaging device for providing depth images of the hand and an object held by the hand; and
a controller including a machine learning policy computation module for processing data determined from the depth images of the object held by the hand to provide commands for the hand to reorient the object while maintaining support of the object during the reorientation.

2. The robotic system of claim 1 wherein the machine learning policy computation module further processes a three-dimensional representation of a position of the hand and a three-dimensional representation of a desired orientation of the object to provide the commands, to provide the commands.

3. (canceled)

4. The robotic system of claim 2 wherein the data determined from the depth images, the three-dimensional representation of the position of the hand, and the three-dimensional representation of the desired orientation of the object are point cloud representations.

5. (canceled)

6. The robotic system of claim 1, further comprising a training system for determining values of configurable parameters of the policy computation module by processing data representing simulated manipulation of a plurality of shapes of objects by the hand, and wherein the robotic system is configured to update the values of configurable parameters based on real or simulated experience manipulating one or more objects, and wherein a training procedure and/or the updating of values of configurable parameters makes use of a reinforcement learning (RL) approach.

7. (canceled)

8. (canceled)

9. (canceled)

10. (canceled)

11. (canceled)

12. (canceled)

13. (canceled)

14. (canceled)

15. The robotic system of claim 1, wherein the policy computation module further receives an input representing a desired change of orientation of the object.

16. The robotic system of claim 1, wherein the robotic system operates an artificial neural network in a control loop whereby said artificial neural network repeatedly receives input data and outputs command data for the hand.

17. The robotic system of claim 16, wherein the artificial neural network comprises a recurrent neural network or other neural network structure that maintains states between inputs.

18. The robotic system of claim 17, wherein the artificial neural network implements a sparse convolutional network.

19. (canceled)

20. The robotic system of claim 6, wherein the reinforcement learning (RL) approach learns from simulated experience of an effect of hand commands on changes in orientation of the object, wherein the simulated experience is determined using a simulator of mechanical behavior of the hand and object, wherein the mechanical behavior of the hand is based on a parameterized dynamical model of the hand, and the mechanical behavior of the hand is learned prior to the reinforcement learning, including by performing a system identification procedure.

21. (canceled)

22. (canceled)

23. (canceled)

24. The robotic system of claim 1, wherein the plurality of fingers have rigid skeletons covered in a soft gel elastomer, which provides compliance in fingertips of the plurality of fingers while an endoskeleton helps to maintain integrity of shapes of the plurality of fingers while manipulating objects.

25. The robotic system of claim 24, wherein a system identification procedure includes a parallel search for mechanical system parameter values, for instance, evaluating many different sets of system parameters in parallel to identify parameters that best match recordings of true physical behavior of the hand.

26. (canceled)

27. The robotic system of claim 20, wherein the simulated experience includes simulated point clouds determined from simulated positions and orientations of the hand and object being manipulated without necessarily simulating an image acquisition procedure.

28. The robotic system of claim 6, wherein the reinforcement learning approach rewards motion toward a goal orientation.

29. The robotic system of claim 6, wherein the reinforcement learning approach penalizes motion associated with possible dropping of an object being manipulated.

30. The robotic system of claim 6, wherein the reinforcement learning approach penalizes when the object contacts a surface disposed below the object, thereby rewarding manipulation (reorientation) that is performed entirely above the surface.

31. The robotic system of claim 30, wherein, during the training procedure, the surface is removed or modified in the simulation once a certain level of manipulation performance is achieved through the training.

32. The robotic system of claim 6, wherein a simulator of mechanical behavior of the hand is updated during actual manipulation of an object, and further simulated behavior is generated and used by the reinforcement learning approach to further update the values of configurable parameters.

33. The robotic system of claim 1, wherein the imaging device provides depth data, and the policy computation module is configured to process point cloud data determined from the depth data and representing a combination of an object supported by the hand and the configuration of the hand.

34. The robotic system of claim 33, wherein other manipulator data such as contact forces (e.g., pressure, sheer) on the fingers may be combined with the point cloud data.

35. (canceled)

36. A non-transitory machine-readable medium having instructions stored thereon, said instructions when executed by a processor integrated into a robotic system cause the processor to
acquire depth images of an object and a hand of the robotic system having a plurality of fingers; and
control the hand with a controller of the robotic system, the controller including a policy computation module for processing data determined from the depth images to provide commands for the hand to reorient the object held in the hand while maintaining support of the object during the reorientation.
